(19) United States
(12) Patent Application Publication
(10) Pub. No.: US 2017/0052053 A1
(43) Pub. Date: Feb. 23, 2017

(54) WATER LEVEL SENSOR

(71) Applicant: OKAZAKI MANUFACTURING COMPANY, Hyogo (JP)

(72) Inventor: Masaru YAMANA, Hyogo (JP)

(73) Assignee: OKAZAKI MANUFACTURING COMPANY, Hyogo (JP)

(21) Appl. No.: 15/039,207

(22) PCT Filed: Mar. 4, 2014
(86) PCT No.: PCT/JP2014/001196

§ 371 Date: May 25, 2016

(30) Foreign Application Priority Data
Dec. 3, 2013 (JP) 2013-249844

(51) Int. Cl. G01F 23/24

(52) U.S. Cl. CPC G01F 23/246

(57) ABSTRACT

It is aimed to provide an inexpensive water level sensor capable of improving accuracy. The water level sensor includes a heat generating body 9 operable to generate heat by an electricity, a thermocouple 12 having a temperature measurement point 123 arranged adjacent to the heat generating body 9, a protection tube 13 for housing these heat generating body 9 and thermocouple 12 and an insulating material 14 filled in this protection tube. The heat generating body 9 includes a platinum resistive element 9 as a heat source.

### TECHNICAL FIELD

The present invention relates to a water level sensor for detecting a water level of water contained in a container utilizing a heat generating body and a thermocouple.

### BACKGROUND ART

Conventionally, a water level sensor of this type is widely used as an industrial sensor for detecting water levels of various containers as a water level gauge. For example, a water level sensor shown in patent literature 1 includes, as a water level gauge of a so-called heating thermocouple type, a long and narrow heat generating wire extending in one direction and configured to generate heat by an electricity, a thermocouple having a temperature measurement point arranged adjacent to this heat generating wire, a protection tube configured to house the heat generating wire and the thermocouple and an insulating material filled in this protection tube, and is arranged in the container with its longitudinal direction aligned with a depth direction of the container. Since the amount of heat radiated from the heat generating wire differs between in water and in gas, this water level gauge detects a water level utilizing a temperature difference at the temperature measurement point of the thermocouple in each of these states. Specifically, this water level sensor causes the heat generating wire to generate heat by energizing the heat generating wire, and the temperature of the heat generating wire and that in an area near the heat generating wire are lower when the water level sensor is in water than when the water level sensor is in gas since the amount of radiated heat is more when the water level sensor is in water than when the water level sensor is in gas. Thus, this temperature is measured by the thermocouple and it is discriminated that the water level sensor is in water when the measured temperature is lower than a predetermined reference temperature.

In the water level sensor described in patent literature 1, the heat generating wire extends in an axial direction of the protection tube and the tip is bent into a U shape. Note that a Nichrome wire has been used as a material of the heat generating wire.

Since the heat generating wire extends over a relatively wide range in the longitudinal direction (axial direction) of the protection tube in this conventional water level sensor of the heating thermocouple type, a sufficient temperature increase may not be obtained even if the temperature measurement point of the thermocouple is in gas when a part of this heat generating wire is in water. Thus, this water level sensor can detect a rough water level, but does not have a sufficiently high accuracy.

In this case, if the length of the heat generating wire in the longitudinal direction is shortened in the conventional water level gauge, it leads to a reduction in the amount of heat generation of the heat generating wire. As a result, a temperature difference between when this water level gauge is in water and when it is in gas becomes smaller and it becomes difficult to detect a precise water level. Further, if a large current is caused to flow in this heat generating wire to obtain a sufficient amount of heat generation for this short heat generating wire, a large power supply for applying a large current is necessary. Alternatively, if a heat generating wire using a Nichrome wire is densely arranged to obtain a sufficient amount of heat generation, new facility and technology development for this dense arrangement are necessary. As just described, if the length of the conventional water level gauge is simply shortened in the longitudinal direction, it may lead to a cost increase in building a water level detection system.

### CITATION LIST

### Patent Literature

Patent literature 1: Japanese Unexamined Patent Publication No. HEI08-220284

### SUMMARY OF INVENTION

The present invention was developed in view of conventional problems as just described and aims to provide a water level sensor having an improved accuracy and a suppressed price.

To solve the above problem, a water level sensor according to this invention includes a heat generating body operable to generate heat by an electricity, a thermocouple having a temperature measurement point arranged adjacent to the heat generating body, a protection tube for housing the neat generating body and the thermocouple and an insulating material filled in the protection tube, the heat generating body including a platinum resistive element as a heat source. Note that “adjacent to the heat generating body” is a concept including a position near the heat generating body besides a position in contact with the heat generating body.

Existing platinum resistive elements are widely used for temperature measurement. According to this invention, the platinum resistive element is used not for temperature measurement, but as the heat source of the heat generating body. Thus, the heat generating body can be inexpensive and have a small size as compared to the case where a comparable amount of heat generation is ensured using a heat generating wire using an existing Nichrome wire.

Specifically, in the heat generating body using the existing Nichrome wire as the heat source, it is difficult to obtain a sufficient amount of heat generation while having the size of the platinum resistive element. Even if that amount of heat generation is obtained by densely arranging the heat generating wire using a thin Nichrome wire, fabrication cost is expected to be high. In contrast the platinum resistive element is inexpensively available as a general-purpose product for temperature measuring resistive element. Further, since a sufficient amount of heat generation can be obtained with a small current, the cost of a water level detection system including this water level sensor can also be suppressed.

Thus, according to this invention, the heat generating body capable of obtaining a sufficient amount of heat generation in a range narrow in a longitudinal direction can be inexpensive, wherefore a sensor can have improved water level detection accuracy while being inexpensive as compared to a water level sensor using a heat generating wire using a conventional Nichrome wire.

### BRIEF DESCRIPTION OF DRAWINGS

FIG. 1 is a conceptual diagram schematically showing a water level detection system using a water level sensor according to one embodiment of the present invention,

FIG. 2 is a partial sectional view of the water level sensor according to the one embodiment,

FIG. 3 is a sectional view showing a resistive element used in the water level sensor of FIG. 2 as an example,

FIG. 4 is a partial sectional view of a water level sensor according to another embodiment of the present invention,

FIG. 5 is a partial sectional view of a water level sensor according to still another embodiment of the present invention, and

FIG. 6 is a sectional view along line VI-VI of FIG. 5.

### DESCRIPTION OF EMBODIMENTS

Hereinafter, one embodiment of the present invention is described with reference to the drawings. Note that a water level sensor of this embodiment is applicable for detection of a water level in various containers of a nuclear facility such as a pressure container and a vapor generator as well as any container capable of storing water, and is not limited to a particular application object.

### (1) First Embodiment

FIG. I is a conceptual diagram schematically showing a water level detection system using a water level sensor according to one embodiment of the present invention.

This water level detection system I is for detecting a water level of storage tank (container) T storing water inside. Specifically, the water level detection system 1 includes a water level sensor 2 arranged at a predetermined height of the storage tank T, a power supply 4 for supplying power to this water level sensor 2 and a temperature meter 5 for measuring a temperature based on information from the water level sensor 2 and judging whether the measured temperature is higher or lower than a reference temperature. Whether or not water has reached a height position of the water level sensor 2 is determined based on the above judgment in the temperature meter 5 by electrically connecting cables 6, 7 of the water level sensor 2 respectively to the power supply 4 and the temperature meter 5.

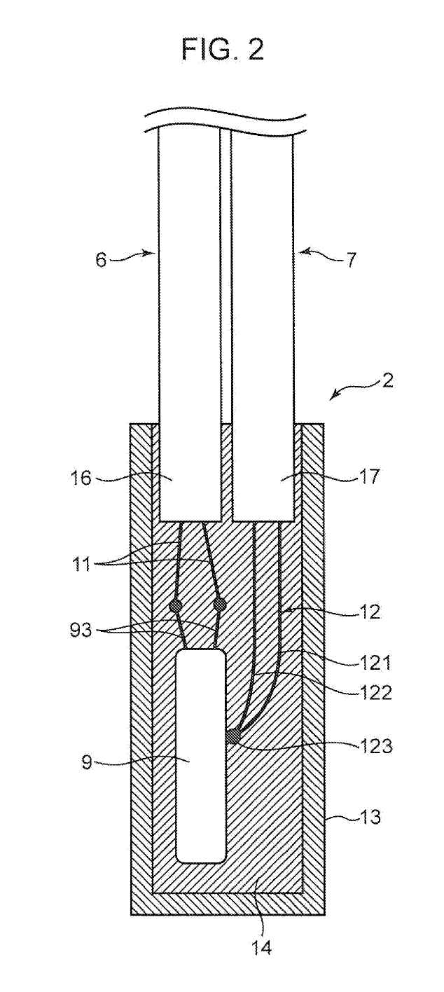

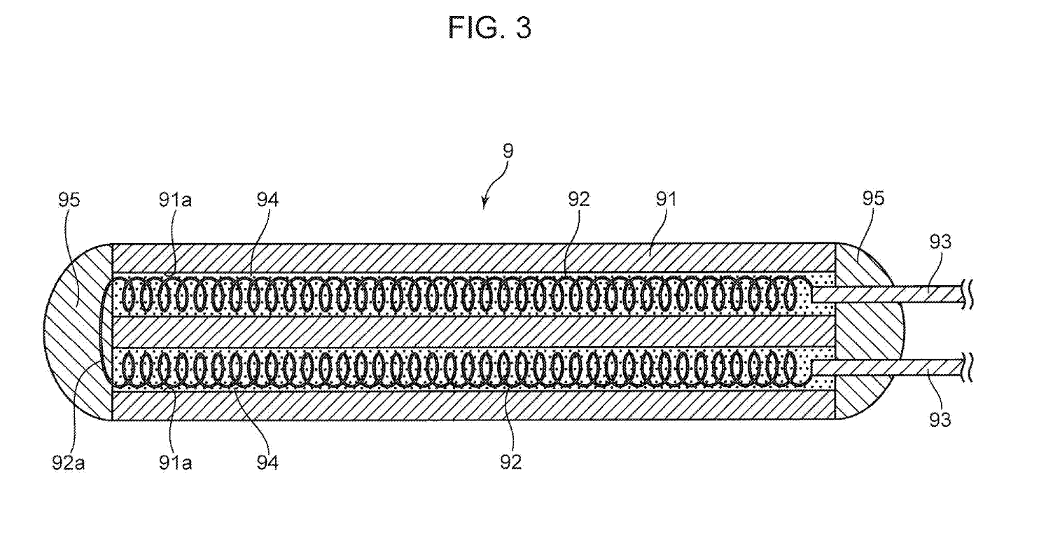

FIG. 2 is a partial sectional view of the water level sensor 2 according to the first embodiment. Note that, in FIG. 2, not cross-sections, but external appearances of a resistive element, heat generating lead wires, thermocouple wires and waterproof coating portions are shown. Further, FIG. 3 is a sectional view showing the resistive clement used in this water level sensor 2 as an example.

The water level sensor 2 includes the resistive element 9 as a heat generating body operable to generate heat by an electricity, a pair of heat generating lead wires II electrically connected to the resistive element 9, a thermocouple 12 having a temperature measurement point 123 arranged on a surface or the resistive element 9, a protection tube 13 for housing the resistive element 9 and the thermocouple 12 and an insulating material 14 filled in this protection tube 13. This water level sensor 2 is long and narrow in one direction and arranged in the storage tank T such that a longitudinal direction thereof is aligned with a depth direction of the storage tank T.

The resistive element 9 includes a platinum resistance element whose resistor is made of platinum (Pt). In this first embodiment, an existing platinum resistive element having a nominal resistance value of 100 Ω, specifically, the one used in a temperature measuring resistor corresponding to Pt100 (in accordance with JIS C1604-1997) is adopted as the resistive element 9. In the present invention, this resistive element 9 is used as a heat generating body instead of being used for temperature measurement as an original purpose.

Note that although the resistive element used in Pt100 specified in JIS C1604 (established in 1997) is adopted as the resistive element 9 of this embodiment, this standard may be JIS C1604 (established in 2013), IEC60751 (established in 2008) or ASTM E1137 (established in 1995), which is an international standard. Specifically, the type of the resistive element 9 does not matter if the resistive element 9 is a resistive element used in a platinum temperature measuring resistor specified by the national standards or international standards such as JIS, ASTM or IEC or specified in the past. However, in terms of high versatility, it is preferable to adopt a platinum resistive element used in a temperature measuring resistor specified by the currently established standards.

Platinum used in this resistive element 9 has a higher melting point (1768.3° C.) and a higher thermal conductivity (72 W·m⁻¹·K⁻¹) than Nichrome (nickel chrome). On the other hand, platinum has a lower linear expansion coefficient (8.8×10⁻⁶·K⁻¹) than Nichrome. Thus, the resistive element 9 is advantageous as compared to a Nichrome wire in being able to evenly heat the entire element even in a severe environment.

More specifically, a so-called winding-type resistive element is used as the resistive element 9 as shown in FIG. 3. Specifically, the resistive element 9 includes a column-like insulator 91 having two through holes 91a extending along a longitudinal direction, a coiled platinum resistance wire 92 inserted into these through holes 91a and folded at tip sides of the through holes 91a, a pair of inner lead wires 93 respectively electrically connected to opposite end parts of this platinum resistance wire 92, an element insulating material 94 tilled in each through hole 91a of the insulator 91 and sealing portions 95 for sealing both ends of the insulator 91.

A ceramic made of alumina, magnesia, silica or a mixture of these materials is used as the insulator 91, which is formed into a cylindrical shape in external appearance in this embodiment.

The platinum resistance wire 92 used preferably has a very small diameter of, e.g. 50 μm or smaller. In this embodiment, the platinum resistance wire 92 of 25 μm is used. Note that although the diameter of this platinum resistance wire 92 is not particularly limited, platinum resistance wires of 12 to 25 μm are preferably used. Further, a folded part 92a of the platinum resistance wire 92 of this embodiment is not coiled and is a curved wire. Further, the type of platinum used in this platinum resistance wire 92 does not matter if it meets the above specification, but platinum having a purity substantially close to 100% although containing unavoidably remaining impurities is used in this embodiment.

On the other hand, the element insulating material 94 is inorganic insulating material powder and powder made of alumina, magnesia, silica or a mixture of these materials is used. An adhesive mainly containing alumina, magnesia, silica, zircon or a mixture of these materials is normally used as the sealing portions 95 and enamel such as epoxy resin may also be used.

This resistive element 9 is not particularly limited in shape and dimensions, but is formed into a cylindrical body in external appearance as described and has a diameter of 2 mm and a length (axial direction) of 10 mm in this embodiment. The dimensions of this resistive element 9 are preferably small in terms of efficiently generating heat in a maximally narrow range, and the diameter is preferably 5 mm or smaller and further preferably 3 mm or smaller. Further, the length of the resistive element 9 is 25 mm or shorter, preferably 15 mm or shorter and further preferably 10 mm or shorter.

Further, although the resistive element 9 of this embodiment used has a nominal resistance value of 100 Ω, the nominal resistance value is at least 10 Ω, preferably 50 Ω or more and further preferably 100 Ω or more in terms of ensuring a predetermined amount of heat generation. Note that this nominal resistance value may have a predetermined error,

Although the element used in Pt 100 specified in JIS is used as this resistive element 9 as described above, the standards may be the International Standards or National Standards of each country or may be either new or old standards as described above. For example, there is no problem even if the resistive element 9 is an element used in Pt10, Pt100, Pt500, Pt1000 (each Pt indicates platinum and a number following Pt indicates a nominal resistance value at 0° C. This is JIS expression and such an expression is not found in IEC and ASTM. JIS expressions are used in the following description.) specified in JIS, old JIS and IEC or JP150, JPt100 indicates a reference standard in old JIS). However, it is preferable to adopt a nominal resistance value of 100 Ω or larger in terms or obtaining a sufficient amount of heat generation. A resistive element used in Pt100 specified in JIS C1604 (established in 1997 or 2003) or IEC60751 (established in 2008) is best in consideration of the amount of heat generation and because it is a general-purpose product widespread in the marketplace and inexpensively available. A class of a tolerance, a specified current, a usable temperature section and a usable temperature range specified in JIS, IEC or ASTM can be appropriately selected according to usage.

Further, although the winding type element is used as the resistive element 9 of this embodiment as described above, the type of this resistive element is not particularly limited. For example, a so-called thin film type resistive element may be used which is formed by providing an insulating coating layer of glass, ceramic or the like on a surface of a platinum resistor obtained by molding a platinum thin film such as by deposition on a thin film substrate made of ceramic, alumina or the like. Both winding type resistive elements and thin film type resistive elements are widely and inexpensively available in the market as Pt100 specified in JIS or IEC and can be used as a heat generating body capable of making the water level sensor inexpensive and obtaining a sufficient amount of heat generation with a small current as described later.

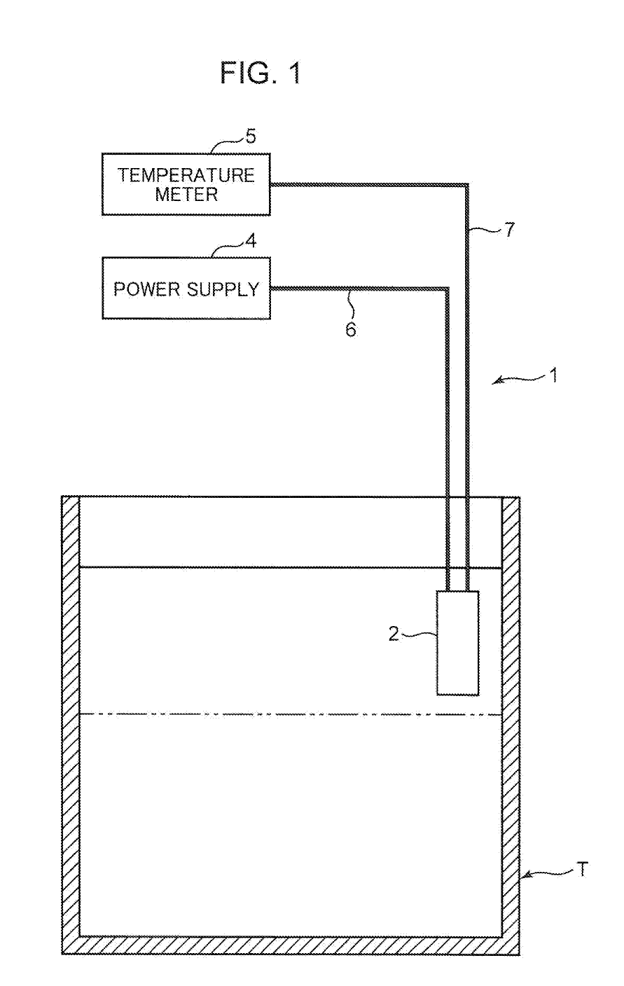

The heat generating lead wires 11 serve as a conductor of the power supply cable 6 and electrically connects the resistive element 9 and the power supply 4 shown in FIG. 1. In the first embodiment, a copper wire is adopted. The pair of heat generating lead wires 11 are provided and respectively electrically connected to the pair of inner lead wires 93 of the resistive element 9. Further, waterproofing is applied to the heat generating lead wires 11 except tip terminal portions to be connected to the inner lead wires 93 by a waterproof coating portion 16 for coating the heat generating lead wires 11 in a liquid-tight manner. Specifically, the power supply cable 6 is composed of the heat generating lead wires 11 and the waterproof coating portion 16 as main constituent members. An unnecessary part of this waterproof coating portion 16 may be omitted.

This waterproof coating portion 16 is formed of waterproof synthetic resin in the first embodiment. More specifically, fluororesin (above all, FEP) is adopted. Note that each of the pair of heat generating lead wires 11 in the waterproof coating portion 16 is insulation-coated to prevent mutual short-circuiting, and the waterproof coating portion 16 is formed outside the insulation coatings. A tip part of the waterproof coating portion 16 is arranged in the protection tube 13 and reliable waterproofing is applied by the insulating material 14.

Note that, besides fluororesin, known waterproof synthetic resins such as silicon rubber and ethylene propylene rubber can be adopted as the waterproof synthetic resin constituting, the waterproof coating portion 16 in this first embodiment.

The thermocouple 12 is a known thermocouple and is a temperature sensor, in which a joint portion of thermocouple wires 121, 122 made of different metals serves as the temperature measurement point 123, utilizing a property that a generated thermoelectromotive force differs depending on the temperature at the temperature measurement point 123. The type of this thermocouple 12 is not particularly limited and may be a T thermocouple or the like. In the first embodiment, a K thermocouple is adopted. The thermocouple wires 121, 122 are lead wires of the cable 7, and waterproofing is applied to the thermocouple wires 121, 122 except predetermined ranges of tip parts by a waterproof coating portion 17 for coating the thermocouple wires 121, 122 in a liquid-tight manner similarly to the above heat generating lead wires 11. Specifically, the thermocouple cable 7 is composed of the thermocouple wires 121, 122 and the waterproof coating portion 17 as main constituent members. Note that although these thermocouple wires 121, 122 are also used as inner lead wires of the cable 7 in this embodiment, they may be formed separately from the inner lead wires of the cable 7 and electrically connected to these inner lead wires. Further, an unnecessary part of this waterproof coating portion 17 may be omitted.

This waterproof coating portion 17 differs from the waterproof coating portion 16 only in that coating objects are not the beat generating lead wires 11, but the thermocouple wires 121, 122 and is the same as the waterproof coating portion 16 in the other configuration including the arrangement of the tip parts in the protection tube 13 and the insulation coating of each lead wire. Thus, the detail of the waterproof coating portion 17 is not described.

The temperature measurement point 123 of this thermocouple 12 is arranged in contact with the surface of the resistive element 9. Specifically, the temperature measurement point 123 is arranged in contact with a central part of the resistive element 9 in the longitudinal direction (axial direction) and measures the temperature of the resistive element 9. Note that although this temperature measurement point 123 is arranged in contact with the surface of the resistive element 9 in terms of reliable temperature measurement in the first embodiment, it may be spaced apart from the resistive element 9 if the temperature of the resistive element 9 or that in an area near the resistive element 9 is measurable. Also in this case, the temperature measurement point 123 is preferably arranged to correspond to a certain longitudinal part of the resistive element 9.

The protection tube 13 is for housing the resistive element 9 and the temperature measurement point 123 of the thermocouple 12 and formed into a tubular shape. Specifically, the resistive element 9 is housed in the protection tube 13 such that the longitudinal direction thereof extends along (substantially along) the axial direction of the protection tube 13.

Although the protection tube 13 is formed into a bottomed cylindrical shape in the first embodiment, a tube body open on opposite ends can be used if the insulating material 14 to be filled is waterproof. Although stainless steel (SUS) is used as a material of this protection tube in the first embodiment, other material can be appropriately selected in consideration of an installation site of the water level sensor. Metal such as copper, corrosion-resistant and beat-resistant superalloy, or curable resin such as silicon rubber, epoxy resin may be used, Dimensions of this protection tube 13 are not particularly limited if the resistive element 9 and a part of the thermocouple 12 can be housed therein. In the first embodiment protection tube having outer diameter of 6.0 mm, a thickness of 0.5 mm and a length of 30 mm is used in the light of the dimensions of the resistive element 9. Note that the outer diameter of the protection tube 13 is preferably 10.0 mm or smaller, the thickness thereof is preferably 0.7 mm or smaller and the length thereof is preferably 50 rum or shorter. If the outer diameter and the thickness of the protection tube are excessive, a temperature difference between in water and in gas is reduced, the accuracy of water level detection drops and a thermal capacity increases to cause a delay in water level detection.

The intrusion of water into the protection tube 13 needs to be prevented since it causes a short circuit of the heat generating lead wires 11, the inner lead wires 93 and the thermocouple wires 121, 122 and the resistive element 9 may not be water-resistant. Since waterproof resin is adopted as the insulating material 14 as described later in the first embodiment, the protection tube 13 may not be held air-tight and liquid-tight. However, if the insulating material 14 is not waterproof, it is better to hold the protection tube 13 air-tight and liquid-tight using an adhesive or the like to reliably prevent the intrusion of water.

The insulating material 14 is for preventing a short circuit of the heat generating lead wires 11 and the thermocouple wires 121, 122 by being filled into the protection tube 13. In the first embodiment, an insulating material having a waterproof property in addition to an electrical insulation property is adopted as the insulating material 14, and the tip parts of the heat generating lead wires 11 and the thermocouple wires 121, 122 including the tip parts of the respective waterproof coating portions 16, 17 are scaled by this insulating material 14.

Specifically, silicon rubber is adopted as the insulating material 14, but other waterproof insulating resin such as epoxy resin may be used. Further, if the insulating material 14 needs not be waterproof, inorganic insulating material powder, specifically, powder made of alumina, magnesia, silica or a mixture of these may be used.

On the other hand, referring back to FIG. 1, the power supply 4 is for supplying power to the water level sensor 2 and the water level sensor 2 of the first embodiment obtains the amount of heat generation necessary to energize the resistive element 9 at about 120 mA. Thus, a small-size and simple power supply such as a dry-cell battery or a solar cell can be used as the power supply 4. An electric current is appropriately selected in terms of ensuring a sufficient amount of heat generation, but is preferably 20 to 600 times as large as a specified current of the resistive element 9. In a prototype test, it was confirmed that a water level could be constantly accurately detected by generating heat by causing a current of 120 mA to flow by a power supply of 12 V obtained by combining a solar cell panel and a storage battery and also operating the temperature meter 5 by this power supply. This indicates an advantage of being capable of water level detection even in a place where a factory power supply of 100 V or the like is absent.

The temperature meter 5 is for measuring the temperature at the temperature measurement point 123 from the thermoelectromotive force of the thermocouple 12 and, in the first embodiment, also has a function of notification when a predetermined temperature (reference temperature) is exceeded. This reference temperature is determined in advance based on the temperature measured when the water level drops below the water level sensor 2. Thus, this temperature meter 5 notifies that the water level has dropped below the water level sensor 2 when the temperature measured by the thermocouple 12 exceeds the reference temperature. Note that, concerning the notification function of the temperature meter, notification may be given when the temperature drops below the reference temperature. Further, these power supply 4 and temperature meter 5 are not described in detail since they are known.

The water level sensor 2 thus configured detects the water level, for example, as follows.

Specifically, when the power supply 4 is first turned on and the resistive element 9 is supplied with electricity, the resistive element 9 generates heat. At this time, the heat generated from the resistive element 9 is efficiently radiated to the water through the insulating material 14 and the protection tube 13 if the water level of the storage tank T has reached the water level sensor 2 as shown by a solid line in FIG 1. Thus, a temperature increase at the temperature measurement point 123 is suppressed and a measured temperature by the thermocouple 12 is measured by the temperature meter 5 as a temperature lower than a later-described measured temperature when the water level sensor 2 is in gas. This temperature is compared with the reference temperature in the temperature meter 5 and it can be judged that the water level has reached the water level sensor 2.

On the other hand, if the water level of the storage tank T has not reached the water level sensor 2 as shown by a chain double-dashed line in FIG. 1, the heat generated from the resistive element 9 is not radiated as much as when the water level sensor 2 is in water. Thus, the temperature at the temperature measurement point 123 increases. Accordingly, the measured temperature by the thermocouple 12 higher than the measured temperature when the water level sensor 2 is in water is measured in the temperature meter 5, compared with the reference temperature in this temperature meter 5 and judged to be higher than the reference temperature, and notification indicating that the water level has dropped below the water level sensor 2 is given.

According to the water level sensor 2 of this first embodiment, it is possible to ensure a sufficient amount of heat generation while having a small size since the resistive element 9 is adopted as the heat generating body. Thus, the dimension of the water level sensor in the height direction of the storage tank T can be made shorter than a conventional sensor using a Nichrome heat generating wire. Therefore, according to this water level sensor 2, a water level detection range can be narrowed due to a short longitudinal dimension, whereby water level detection accuracy is drastically improved,

More specifically, since the water level sensor 2 thus configured uses the resistive element 9 used in a temperature measuring resistive element of Pt100 specified in JIS, IEC or ASTM not for temperature measurement as an original purpose, but as the heat generating body, the heat generating body can be inexpensive and small in size as compared to the case where a comparable amount of heat generation is ensured using a heat generating wire using an existing Nichrome wire and water level detection accuracy can be drastically improved by having a small size.

Specifically, to obtain an electrical resistance value of 100 Ω by a Nichrome wire most general as a conventional heat generating body for a water level sensor, a length of about 18 meters is necessary even if a Nichrome wire having a diameter of 0.5 mm is used, and it is difficult to make the size equal to that of the resistive element 9 as described above while suppressing production cost. Thus, it will be seen that to make a predetermined amount of heat generation by a power supply equivalent to the power supply 4 using a Nichrome wire as a heat generating body, the sensor will have a large size. In such a large sensor, a water level cannot be accurately detected when a part of the sensor is immersed in water, consequently reducing the water level detection accuracy. On the other hand, if the length of the Nichrome wire is shortened to the same size as the resistive element 9, a reduction in the electrical resistance value has to be compensated for by an increase of the electric current. Thus, the power supply has to have a large size to maintain the amount of heat generation, which thus makes it difficult to produce an inexpensive water level detection system in entirety.

In contrast according to the water level sensor 2 of the first embodiment, the existing platinum resistive element 9 is used as the heat generating body. The resistive element 9 is inexpensively available as a wide use product and a sufficient amount of heat generation can be obtained with small power by the resistive element haying a small size. Thus, water level detection accuracy can be drastically improved while the cost of the water level detection system 1 including this water level sensor 2 is suppressed.

Further, since the heat generating lead wires 11 and the thermocouple wires 121, 122 are respectively coated in a liquid-tight manner by the waterproof coating portions 16, 17 in this water level sensor 2, a waterproof function is enhanced and, associated with this, convenience is improved.

### (2) Second Embodiment

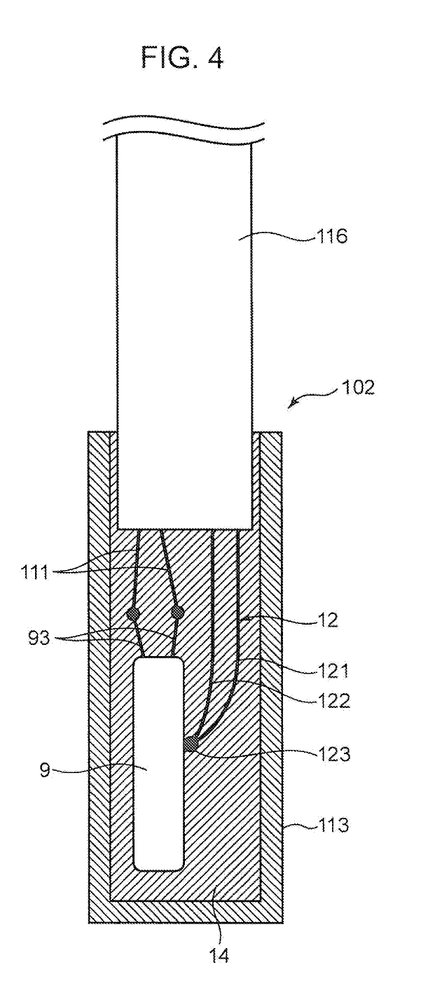

Next, another embodiment of the present invention is described on the basis of FIG. 4. FIG. 4 is a sectional view, corresponding to FIG. 2, showing a water level sensor of this second embodiment.

A water level sensor 102 of this second embodiment differs from the water level sensor 2 of the first embodiment only in a waterproof coating structure for heat generating lead wires and thermocouple wires. Specifically, waterproof coating is individually applied to the heat generating lead wires 11 and the thermocouple wires 121, 122 by the waterproof coating portions 16, 17 in the water level sensor 2 of the first embodiment. However, the water level sensor 102 of the second embodiment differs in that waterproof coating is collectively applied to heat generating lead wires 111 and thermocouple wires 121, 122.

Specifically, this water level sensor 102 includes a pair of heat generating lead wires 111 formed of thermocouple wires, which are the same material as the thermocouple wires 121, 122 (specifically, K thermocouple wires) instead of the heat generating lead wires 11 formed of copper wires, and waterproof coating is collectively applied to these heat generating lead wires 111 and the thermocouple wires 121, 122 by a waterproof coating portion 116. This waterproof coating portion 116 is the same as in the first embodiment also in that the waterproof coating portion 116 is made of waterproof synthetic resin such as fluororesin similarly to the waterproof coating portion 16 of the first embodiment, each of the wires 111, 121 and 122 is insulation-coated to prevent mutual short-circuiting, and waterproof coating is applied outside the wires.

Further, since waterproof coating is collectively applied to the heat generating lead wires 111 and the thermocouple wires 121, 122 in this water level sensor 102, this collective cable can be made thinner than the cables of the first embodiment, whereby an outer diameter of a protection tube 113 can be made smaller than that of the protection tube 13 of the first embodiment. Thus, in the water level sensor 102 of this second embodiment, heat can be efficiently transferred between inside and outside since the outer diameter of the protection tube 113 is reduced, whereby accuracy and responsiveness can be improved as compared to the water level sensor 2 of the first embodiment.

Further, since the lead wires made of the same material as the thermocouple wires 121, 122 are adopted as the heat generating lead wires 111, a commercially available thermocouple cable in which waterproof coating is collectively applied to two pairs of wires can be utilized. Out of these thermocouple wires, one pair of thermocouple wires can be utilized as the thermocouple wires and the other pair can be utilized as the heat generating lead wires 111, whereby an economically improving effect can be obtained. Further, effects and features other than those described above are the same as in the first embodiment.

### (3) Third Embodiment

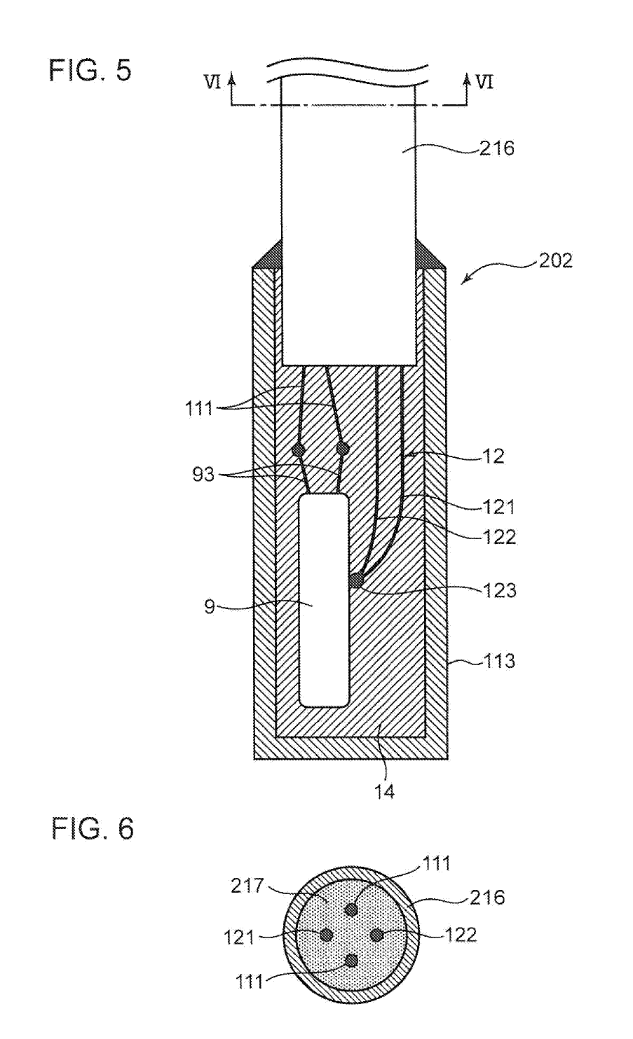

Next, still another embodiment of the present invention is described on the basis of FIG. 5. FIG. 5 is a sectional view, corresponding to FIG. 2, showing a water level sensor of this third embodiment. FIG. 6 is a sectional view along line VI-VI of FIG. 5.

A water level sensor 202 of this third embodiment differs from the water level sensor 2 (sic, 102) of the second embodiment in a specific structure of a waterproof coating portion for heat generating lead wires and thermocouple wires. Specifically, waterproof coating is collectively applied to the heat generating lead wires 111 and the thermocouple wires 121, 122 by the waterproof synthetic rein in the water level sensor 102 of the second embodiment. However, the water level sensor 202 of the third embodiment differs in that waterproof coating is applied to heat generating lead wires 111 and thermocouple wires 121, 122 by a metal sheath tube 216 with a sheathing insulating material 217 interposed. Specifically, a waterproof coating portion of this third embodiment is formed of a so-called MI cable including this metal sheath tube 216 and the sheathing insulating material 217 made of inorganic insulating material powder. This water level sensor 202 is similar to the water level sensor 102 of the second embodiment in a protection tube 113 narrow in diameter, the heat generating lead wires 111 made of the same materials as the thermocouple wires 121, 122 and functions of these.

Specifically, the waterproof coating portion of this water level sensor 202 includes the metal sheath tube 216 housing the heat generating lead wires 111 and the thermocouple wires 121, 122 except tip parts thereof and the sheathing insulating material 217 filled in this metal sheath tube 216, and a tip part of the metal sheath tube 216 is bonded to the protection tube 113 in an air-tight and liquid-tight manner while being inserted in the protection tube 111.

The metal sheath tube 216 is not limited to a particular material as far as the metal sheath tube 216 can be bonded to the protection tube 113. Here, the metal sheath tube is made of stainless steel as for the protection tube 113 of the second embodiment. Although magnesia powder, which is an inorganic insulating material, is used as the sheathing insulating material 217, the sheathing insulating material is not limited to a particular material. The sheathing insulating material 217 may be inorganic insulating material powder such as alumina powder or silica powder instead of magnesia powder.

This metal sheath tube 216 is welded over the entire circumference on a base end part of the protection tube 113 and bonded to the protection tube 113 in an air-tight and liquid-tight manner with the tip part inserted in the protection tube 113. Note that this bonding method is not particularly limited if the both can be bonded in an air-tight and liquid-tight manner and the metal sheath tube 216 may be brazed over the entire circumference instead of being welded over the entire circumference.

An insulating material 14 filled in the protection tube 113 is not required to be waterproof since the metal sheath tube 216 is bonded to the protection tube 113 in a liquid-tight manner. Further, a hygroscopic property is allowed since the metal sheath tube 216 is bonded to the protection tube 113 in an air-tight manner. Thus, the inorganic insulating material powder is filled. The insulating material powder has such a property that moisture is absorbed and insulation is reduced. However, since the metal sheath tube 216 is bonded to the protection tube 113 in an air-tight manner, even if the insulating material 14 is the inorganic insulating material powder, there is no possibility that water level detection is adversely affected due to reduced insulation. The same holds true for the inorganic insulating material powder of the sheathing insulating material 217.

As just described, the water level sensor 202 of the third embodiment is operated by a small-size power supply and can accurately and quickly detect the water level as in the first and second embodiments and water level detection accuracy is drastically improved. In addition, according to this water level sensor 202, waterproof synthetic resin is not used for the waterproof coating portion and the insulating materials and the waterproof coating portion is formed of the metal sheath tube 216 and the inorganic insulating material powder unlike in the second embodiment. Thus, heat resistance is improved and the water level sensor 202 is usable also in an environment of several hundreds of Celsius degrees as compared to the case where waterproof synthetic resin is used.

Next, a test result of the water level sensor 202 of the third embodiment is described. Data obtained from a test conducted by the water level sensor 202 using an existing winding type resistive element having a diameter of 0.8 mm and a length (axial direction) of 10 mm and used in a temperature measuring resistor of Pt100 specified in JIS C1604 as the resistive element 9 and the protection tube 113 having an outer diameter of 1.8 mm, a thickness of 0.06 mm and a length of about 30 mm is shown below. In the test, a water level of water placed in a room having the same temperature as an indoor temperature was detected.

Specifically, the resistive element 9 is supplied with an electricity, a temperature difference between when the water level sensor 202 is in water and when the water level sensor 202 is in air (in gas) is measured, and it is judged that accurate water level detection is possible when this temperature difference is 10° C. or more.

Specifically, a measured temperature difference between in water and in air was 13° C. in the case of energizing the resistive element 9 with a power supply voltage of about 2 V and a current of 20 mA, and a measured temperature difference between in water and in air was 29° C. in the case of energizing the resistive element 9 with a power supply voltage of about 3 V and a current of 30 mA.

This result shows that accurate water level detection is possible even with 2V and a very small current of about 20 mA and also shows that similar water level detection is possible with a current which is at least ten times as large as a specified current of 2 mA specified in JIS C1604 of the resistive element 9.

Note that the water level sensors described above are exemplary water level sensor of the present invention and specific configurations and the like can be appropriately changed without departing from the gist of the present invention. Modifications of these embodiments are described below.

Although the specific configuration when a temperature change at the installation site is small is described in the water level sensor 2, 102, 202 of each of the above embodiments, the water level of the storage tank T can be accurately detected by adding the following configuration when a temperature variation is large.

Specifically, when a temperature variation at an installation site is large, that temperature variation affects the measured temperature at the temperature measurement point 123 by the thermocouple wires 121, 122 of the water level sensor 2. Thus, whether the water level sensor 2 is in water or in gas cannot be discriminated based on the magnitude of the single measured temperature by this thermocouple 12. In such a case, a temperature sensor for measuring a temperature in the storage tank T is separately provided, and the water level can be precisely detected by monitoring a difference between the measured temperature by this temperature sensor and the measured temperature by the thermocouple 12.

Note that the specific embodiments described above mainly include one aspect of the invention having the following configuration.

A water level sensor according to this invention includes a heat generating body operable to generate heat by an electricity, a thermocouple having a temperature measurement point arranged adjacent to the heat generating body, a protection tube for housing the heat generating body and the thermocouple and an insulating material filled in the protection tube, and the heat generating body includes a platinum resistive element as a heat source. Note that “adjacent to the heat generating body” is a concept including positions near the heat generating body besides positions in contact with the heat generating body.

According to this invention, since the existing platinum resistive element is used as the heat source of the heat generating body instead of being used for temperature measurement as an original purpose, the heat generating body can be inexpensively configured to have a small size as compared to the case where a comparable amount of heat generation is ensured using a heat generating wire using an existing Nichrome wire.

Specifically, in the heat generating body using the existing Nichrome wire as the heat source, it is difficult to obtain a sufficient amount of heat generation while having the size of the platinum resistive element. Even if that amount of heat generation is obtained by densely arranging the heat generating wire using a thin Nichrome wire, fabrication cost is expected to be high. In contrast, the platinum resistive element is inexpensively available as a wide use product for temperature measuring resistive element. Further, since a sufficient amount of heat generation can be obtained with a small current, the cost of a water level detection system including this water level sensor can also be suppressed.

Thus, according to this invention, the heat generating body capable of obtaining a sufficient amount of heat generation in a range narrow in a longitudinal direction can be inexpensively configured, wherefore a sensor can have improved water level detection accuracy while being inexpensive as compared to a water level sensor using a heat generating wire using a conventional Nichrome wire.

Note that the temperature measurement point is preferably set in a longitudinal central part, for example, when the heat generation density of the heat generating body in a vertical direction (longitudinal direction) is specifically uniform. Specifically, since the longitudinal central part of the heat generating body has a highest temperature, a temperature difference between in water and in gas is large there and discrimination by the thermocouple as to whether the water level sensor is in water or in gas can be accurately made,

There are roughly two types of commercially available resistive elements, i.e. winding type resistive elements in which a platinum resistance wire in a coil form is reciprocatively inserted into a ceramic insulator having two through holes and is fixed by filling insulating powder into the through holes and thin film type resistive elements in which a platinum thin film is formed as a platinum resistance wire on a thin film of ceramic or the like and insulation coating is applied to the surface of the platinum resistance wire.

The winding type resistive elements have generally a length of no greater than 20 mm and a diameter of no greater than 3 mm. The thin film type resistive elements are even smaller.

In this invention, the size of the platinum resistive element is not particularly limited if the platinum resistive element can be housed in the protection tube, but a length of the protection tube in an axial direction is preferably 25 mm or shorter, further preferably 15 mm or shorter and even more preferably 10 mm or shorter.

If this configuration is adopted, a sufficient amount of heat generation can be obtained in a narrower range by using a commercially available platinum resistive element, wherefore an inexpensive price and further improvement of the water level detection accuracy can be combined.

Note that the platinum resistive element may be so housed in the protection tube that a maximum dimension out of vertical and horizontal dimensions (diameter is included in the concept of the vertical and horizontal dimensions) and the length extends along a direction orthogonal to the axial direction of the protection tube. However, it is preferable to house the platinum resistive element such that the above maximum dimension extends along the axial direction of the protection tube since the diameter of the protection tube can be small.

In this invention, a nominal resistance value of the platinum resistive element is not particularly limited, but is preferably 10 Ω or larger and further preferably 100 Ω or larger. In this case, a platinum resistive element conforming to Pt100 specified in JIS C1604 is further preferable. Note that the “platinum resistive element conforming to Pt100 specified in JIS C1604” means a platinum resistive element used in a temperature measuring resistor of Pt100 specified in JIS C1604.

If this configuration is adopted, a sufficient amount of heat generation can be obtained with a small current. In addition, the platinum resistive element conforming to Pt100 specified in JIS C1604 can inexpensively configure a heat generating body because of a wide use and capable of obtaining a sufficient amount of heat generation with a small current.

The amount of heat generation is proportional to the product of the square of a current and an electrical resistance. In a heat generating body using an existing Nichrome wire, it is not easy to obtain an electrical resistance comparable to that of a platinum resistor while having the size of the platinum resistive element. If it is attempted to obtain an electrical resistance of 10 Ω by a most general Nichrome wire out of conventional heat generating wires, a length of about 1.8 m is necessary even if a thin Nichrome wire having a diameter of 0.5 mm is used. To house this into the size of the aforementioned resistive element, a highly dense arrangement is required. Even if it can be realized, production cost is high. If it is attempted to obtain a resistance value of 100 Ω, a length ten times as long as that is necessary and that tendency is even stronger. Further, if it is attempted to obtain the amount of heat generation by increasing the electric current without increasing the electrical resistance, the power supply needs to have a large current output. Since the current output is directly related to the scale of the power supply, the power supply is enlarged, thereby causing a drawback that the water level detection system becomes expensive.

Next, the intrusion of water into the protection tube needs to be prevented since it causes a short circuit of the lead wires of the heat generating body and the thermocouple wires and some platinum resistive elements are not water resistant. The above insulating material may not be waterproof if the protection tube has a waterproof functions but is preferably waterproof insulating resin if the protection tube has no waterproof function.

If this configuration is adopted, the intrusion of water into the protection tube can be reliably prevented.

Further, in this invention, it is preferable to further provide heat generating lead wires electrically connected to the heat generating body and a waterproof coating portion for coating at least a part of the heat generating lead wires and thermocouple wires constituting the thermocouple.

If this configuration is adopted, the waterproof function of the water level sensor is enhanced and, associated with this, convenience is improved.

In this case, a specific configuration of the waterproof coating portion is not particularly limited, but the waterproof coating portion preferably includes a metal sheath tube for housing at least a part of the heat generating lead wires and the thermocouple wires and a sheathing insulating material filled in this metal sheath tube, and the protection tube preferably has one end sealed in an air-tight and liquid-tight manner and the other end bonded to the metal sheath tube in an air-tight and liquid-tight manner.

If this configuration is adopted, the rigidity of the water level sensor can be enhanced, high temperature resistant materials can be adopted as the respective materials and use in a high-temperature environment is also possible, wherefore convenience is improved.

1. A water level sensor, comprising a heat generating body operable to generate heat by an electricity, a thermocouple having a temperature measurement point arranged adjacent to the heat generating body, a protection tube for housing the heat generating body and the thermocouple, and an insulating material filled in the protection tube,
the heat generating body including a platinum resistive element as a heat source.

2. A water level sensor according to claim 1, wherein a length of the platinum resistive element in an axial direction of the protection tube is 25 mm or shorter.

3. A water level sensor according to claim 1, wherein the platinum resistive element used has a nominal resistance value of 10 Ω or larger.

4. A water level sensor according to claim 3, wherein the platinum resistive element conforms to Pt100 specified in JIS C1604.

5. A water level sensor according to claim 4, wherein the insulating material is waterproof insulating resin.

6. A water level sensor according to claim 5, further comprising a heat generating lead wire to be electrically connected to the heat generating body and a waterproof coating portion for covering at least a part of the heat generating lead wire and a thermocouple wire constituting the thermocouple in a liquid-tight manner.

7. A water level sensor according to claim 6, wherein the waterproof coating portion includes a metal sheath tube for housing at least a part of the heat generating lead wire and the thermocouple wire, and a sheathing insulating material filled in the metal sheath tube, and the protection tube has one end sealed in an air-tight and liquid-tight manner and the other end bonded to the metal sheath tube in an air-tight and liquid-tight manner.

8. A water level sensor according to claim 1, wherein the platinum resistive element used has a nominal resistance value of 10 Ω or larger.

9. A water level sensor according to claim 8, wherein the platinum resistive element conforms to Pt100 specified in JIS C1604.

10. A water level sensor according to claim 9, further comprising a heat generating lead wire to be electrically connected to the heat generating body and a waterproof coating portion for covering at least a part of the heat generating lead wire and a thermocouple wire constituting the thermocouple in a liquid-tight manner.

11. A water level sensor according to claim 8, wherein the insulating material is waterproof insulating resin.

12. A water level sensor according to claim 8, further comprising a heat generating lead wire to be electrically connected to the heat generating body and a waterproof coating portion for covering at least a part of the heat generating lead wire and a thermocouple wire constituting the thermocouple in a liquid-tight manner.

13. A water level sensor according to claim 1, wherein the insulating material is waterproof insulating resin.

14. A water level sensor according to claim 13, further comprising a heat generating lead wire to be electrically connected to the heat generating body and a waterproof coating portion for covering at least a part of the heat generating lead wire and a thermocouple wire constituting the thermocouple in a liquid-tight manner.

15. A water level sensor according to claim 2, wherein the insulating material is waterproof insulating resin.

16. A water level sensor according to claim 15, further comprising a heat generating lead wire to be electrically connected to the heat generating body and a waterproof coating portion for covering at least a part of the heat generating lead wire and a thermocouple wire constituting the thermocouple in a liquid-tight manner.

17. A water level sensor according to claim 1, further comprising a heat generating lead wire to be electrically connected to the heat generating body and a waterproof coating portion for covering at least a part of the heat generating lead wire and a thermocouple wire constituting the thermocouple in a liquid-tight manner.

18. A water level sensor according to claim 17, wherein the waterproof coating portion includes a metal sheath tube for housing at least a part of the heat generating lead wire and the thermocouple wire, and a sheathing insulating material filled in the metal sheath tube, and the protection tube has one end sealed in an air-tight and liquid-tight manner and the other end bonded to the metal sheath tube in an air-tight and liquid-tight manner.

19. A water level sensor according to claim 2, further comprising a heat generating lead wire to be electrically connected to the heat generating body and a waterproof coating portion for covering at least a part of the heat generating lead wire and a thermocouple wire constituting the thermocouple in a liquid-tight manner.

20. A water level sensor according to claim 19, wherein the waterproof coating portion includes a metal sheath tube for housing at least a part of the heat generating lead wire and the thermocouple wire, and a sheathing insulating material filled in the metal sheath tube, and the protection tube has one end sealed in an air-tight and liquid-tight manner and the other end bonded to the metal sheath tube in an air-tight and liquid-tight manner.
